(19) United States
(12) Patent Application Publication
(10) Pub. No.: US 2026/0102780 A1
(43) Pub. Date: Apr. 16, 2026

(54) FRICTION DRILLED SPRAY HEADER

(71) Applicant: Spraying Systems Co., Wheaton, IL (US)

(72) Inventors: Scot Lightizer, Glendale Heights, IL (US); Justin Harradon, Glendale Heights, IL (US); Cody Richards, Glendale Heights, IL (US); Raymond Perry, Glendale Heights, IL (US)

(21) Appl. No.: 19/353,757

(22) Filed: Oct. 9, 2025

Related U.S. Application Data
(60) Provisional application No. 63/706,432, filed on Oct. 11, 2024.

(51) Int. Cl. B05B 1/20; B05B 15/658; B23P 9/02

(52) U.S. Cl. CPC B05B 1/202; B05B 15/658; B23P 9/02

(57) ABSTRACT

A spray header assembly includes a spray header pipe with an elongated tubular side wall with a hollow interior that defines an internal fluid passageway. The spray header pipe includes a plurality of spray nozzle ports. Each spray nozzle port including a respective mounting opening that extends through the side wall of the spray header pipe and communicates with the internal fluid passageway. Each spray nozzle port including a respective annular extension that extends radially inwardly from an inner surface of the side wall into the internal fluid passageway. Each annular extension extends seamlessly from the header pipe and is formed unitarily from the material of the header pipe. A respective spray nozzle secured in each mounting opening.

### CROSS-REFERENCE TO RELATED APPLICATIONS

This patent application claims the benefit of U.S. Provisional Patent Application No. 63/706,432 filed on Oct. 11, 2024, which is incorporated by reference.

### BACKGROUND OF THE INVENTION

Spraying systems having an elongated header on which a plurality of spray nozzles are supported are used in a variety of different industrial applications. Typically, the spray nozzles are laterally spaced from one another along one side of the header. In general, there are two methods by which the spray nozzles are attached to the header. In a first method, the threaded holes are drilled and tapped into the external wall of the header. The spray nozzles are then screwed into the threaded holes. This method has a number of drawbacks. In particular, cutting threads into a curved pipe wall produces a small number of partial threads for engagement by the spray nozzles. As result, this method often results in leaks or stripped threads. This problem is exacerbated when using thinner walled pipe for the header. However, thicker walled pipe is more expensive and can make the header inappropriate for certain applications, particularly those in which space is limited.

The second method for attaching the spray nozzles allows for the use of thin-walled pipe, but has its own significant drawbacks. The second method involves drilling holes in the wall of the header, placing a threaded insert into each opening and welding the threaded inserts in place on the header. The spray nozzles are then attached to the header via the welded-on, threaded inserts. While the use of the threaded inserts allows for fully functional threads, this method is very time consuming and expensive.

The method requires the machining of the inserts, the machining of the pipe and the welding of the inserts in place on the header. More specifically, the necessary weld to attach the inserts, referred to as a saddle weld, is complex and time-consuming to perform. The threaded inserts can also move during the welding process creating alignment issues. These alignment issues can require the inserts to be repeatedly tapped back into proper alignment during the welding process. Moreover, all of the welds are typically on one side of the header pipe (i.e., the side on which the nozzle are to be attached). Because the welds shrink as they cool, the header pipe itself can be bent into a curved shape as the welds cool. This can require a further step of bending the header pipe back away from the welds in order to produce a straight header.

Accordingly, there are number of problems with existing methods for assembling spray headers. These problems can be a particular issue when providing spray headers that are to be used in applications, such as chemical, pharmaceutical, paper, and food service plants requiring heightened performance characteristics including leak resistance at elevated temperatures and pressures. One such set of characteristics is defined in ASME B31.3.

### OBJECTS OF THE INVENTION

In view of the foregoing, a general object of the present invention is to provide a method for manufacturing and/or assembling spray headers having multiple attached spray nozzles that is less time consuming and expensive than existing assembly methods.

A related object of the present invention is to provide a method for manufacturing and/or assembling spray headers of the foregoing type that allows for the use of thin-walled pipe headers while maintaining leak-free connections between the header and the spray nozzles.

A related object of the present invention is to provide a spray header that is cost-effective to manufacture or assemble while being suitable for applications involving elevated temperatures and pressures.

Other objects and advantages of the invention will become apparent upon reading the following detailed description and upon reference to the drawings. The identified objects are not intended to limit the present invention.

### BRIEF DESCRIPTION OF THE SEVERAL VIEWS OF THE DRAWINGS

FIG. 1 is a side view of an exemplary spray header according to the present invention with multiple attached spray nozzles.

FIG. 2 is a side view of the spray header of FIG. 1 with the spray nozzles removed from their respective mounting openings.

FIG. 3 is a partial, enlarged perspective view of the spray header of FIG. 1 showing several threaded nozzle mounting openings.

FIG. 4 is a partial perspective view of the interior of the spray header of FIG. 1 showing the radially inwardly extending extensions of the mounting openings.

FIG. 5 is a flow chart illustrating an exemplary method for manufacturing and/or assembling the spray header of FIG. 1.

### DETAILED DESCRIPTION OF THE INVENTION

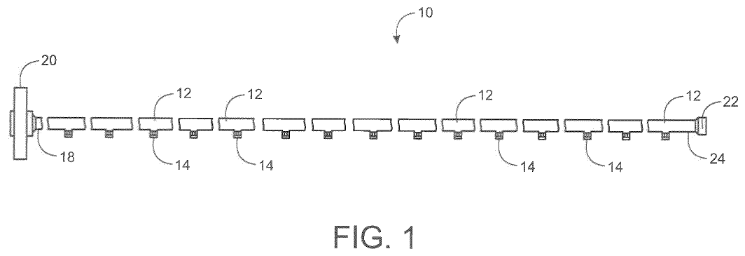

Referring to FIG. 1 of the drawings, there is shown an exemplary embodiment of a spray header assembly 10 according to the present invention. The illustrated spray header assembly 10 generally includes a header pipe 12 described in greater detail below to which are attached a plurality of spray nozzles 14. Spray header assemblies 10 such as illustrated in FIG. 1 are used in many industrial applications for directing a curtain of a fluid into or onto a spray target, such as a processing line. As will become apparent to one skilled in the art, the spray header assembly 10 of the present disclosure may be used to spray various liquid substances, including foods, pharmaceuticals, chemicals, or like substances, in different processing environments.

In this case, the spray nozzles 14 are attached at uniformly spaced intervals laterally along a common side of the header pipe 12 with the spray nozzles 14 oriented such that their respective discharge orifices direct fluid away from the header pipe 12. However, the present invention is not limited to any particular arrangement of the spray nozzles 14 on the header pipe 12 and any spray nozzle arrangement may be used based on the needs of the particular application in which the spray header assembly 10 is to be used. Similarly, the present disclosure is not limited to the use of any particular type of spray nozzle. Again, any desired type of spray nozzle producing any desired spray pattern may be used depending on the needs of the particular application. As described in greater detail below, the spray header assembly 10 of the present application has particular utility in applications, such as chemical, pharmaceutical, paper, and food service plants requiring heightened performance characteristics (e.g., as defined in ASME B31.3) including leak resistance at elevated temperatures and pressures.

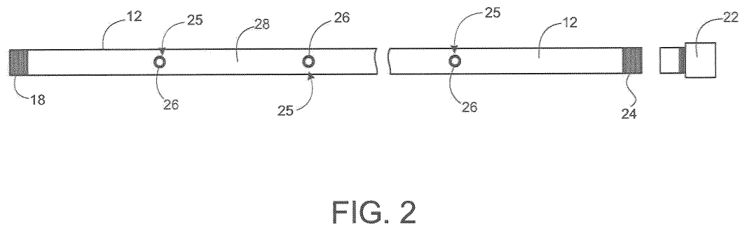

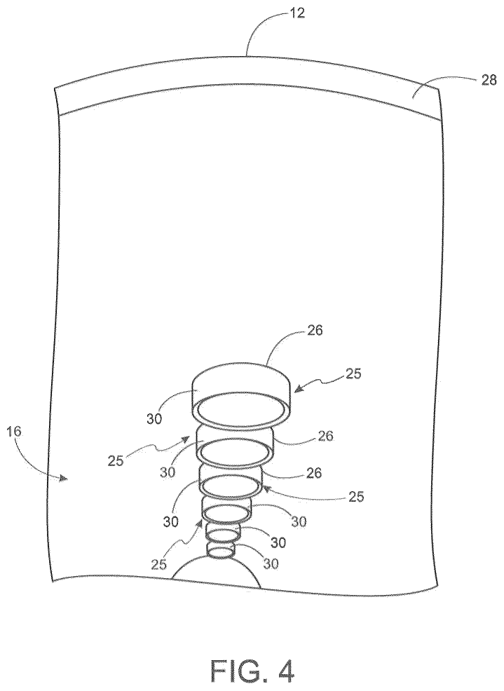

Referring to FIGS. 1-2, the illustrated header pipe 12 has an elongated, generally tubular configuration with in this case a substantially circular cross-section. Header pipes having non-circular cross-sections may also be used. The hollow interior of header pipe 12 defines an internal fluid passageway 16 (see FIG. 4) for distributing fluid to the individual spray nozzles 14 attached to the header pipe 12. The header pipe 12 may be supported in cantilevered relation from a support frame or the like when used in an application. The spray header 12 includes an upstream end 18 that may be connected to a pressurized liquid supply. The spray header illustrated in FIG. 1 includes a mounting flange 20 at the upstream end 16. In this case, an end cap 22 is provided at the downstream end 24 of the header pipe 12 as shown in FIGS. 1 and 2. In other embodiments, a drain pipe or the like may be provided on the downstream end 24 of the header pipe 12 depending on the requirements of the particular application in which it is to be used. As used herein, upstream and downstream are with reference to the direction of the normal flow of fluid through the header pipe 12.

The header pipe 12 may have any desired diameter, schedule and wall thickness. The length of the header pipe 12, the number of spray nozzles 14 and the spacing of the spray nozzles 14 along the header pipe 12 may also vary. In one example, the header pipe 12 may have a diameter of 0.5 inch to 2 inches and may be schedule 10 to schedule 40. In another example, the header pipe may have a wall thickness of up to schedule 80. According to one embodiment, the header pipe 12 may be made of stainless steel. Alternatively, the header pipe may be made of other materials so long as the material used is capable of being friction drilled as described in greater detail below.

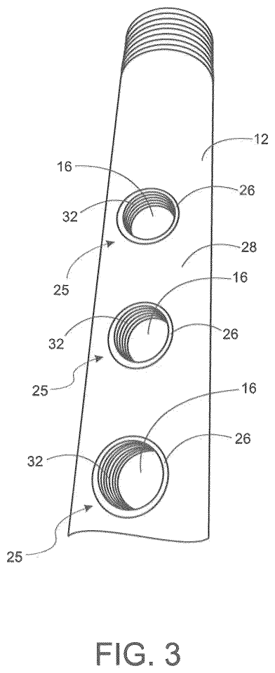

For receiving the spray nozzles 14, the header pipe 12 includes a plurality of spray nozzle ports 25 each of which includes a nozzle mounting opening 26 that extends through the side wall 28 of the header and communicates with the internal fluid passageway therein (see FIGS. 3 and 4). The spray nozzle ports 25 in this case are at uniformly spaced intervals along one side of the header pipe 12. In other embodiments, the intervals between spray nozzle ports 25 may vary along the length of the header pipe 12 and/or spray nozzle ports 25 may be provided on different sides of the header or otherwise not all in alignment depending on the needs or requirements of particular applications.

To help ensure a robust, fluid-tight connection between the spray nozzles 14 and the header pipe 12, each spray nozzle port 25 is produced by friction drilling a nozzle mounting opening 26 through the side wall 28 of the header. Friction drilling is a method of producing openings in metal in which the material is pushed out of the way with the aid of heat from friction. The method may also be called thermal drilling, flow drilling, form drilling, or friction stir drilling. Advantageously, the material that is pushed out of the mounting opening 26 in the side wall 28 of the header pipe 12 during the friction drilling process forms an annular extension 30 (see FIG. 4) that extends radially inwardly from the inner surface of the side wall 28 of the header pipe 12 into the internal fluid passageway 16. These annular extensions 30 extend seamlessly and/or continuously from and are formed from the material of the header pipe 12. As a result, the annular extensions 30 are unitarily formed with the header pipe 12 in contrast to welded inserts. Several of these annular extensions 30 can be seen in FIG. 4, which is a partial, perspective view into the interior of the header pipe 12. Thus, each mounting opening 26 extends from the external surface of the side wall 28 header pipe 12, through the side wall 28 of the header and through the annular extension 30 before reaching the internal fluid passageway 16 of the header. In this way, the depth of each spray nozzle mount 25 exceeds the wall thickness of the header pipe 12.

For securing a spray nozzle 14 in the respective spray nozzle port 25, each nozzle mounting opening 26 is internally threaded as shown in FIG. 3. In particular, the internal threads 32 extend the entire length of the inner wall of the mounting opening 26 including through the annular extension 30 of the spray nozzle port 25. Because of the added depth of the spray nozzle port 25 created by the annular extension 30, the spray nozzle port 25 may be provided with full threads that help ensure a robust, fluid tight connection between the spray nozzle 14 and the header pipe 12 without the need for any complex welding. The internal threads 32 of each spray nozzle port 25 can be configured to mate with an externally threaded portion of a corresponding spray nozzle that is to be mounted in the spray nozzle port 25. The inside diameter of the nozzle mounting openings 26 may vary depending on the spray nozzles 14 to be attached to the header 12. In some circumstances, the spray header pipe 12 may be sold or otherwise supplied without attached spray nozzles. It has been found, that a header with friction drilled nozzle openings as described herein can produce better fluid flow through the internal fluid passage of the header including less turbulence along the centerline of the header pipe than headers with welded nozzle inserts.

The threads in the spray nozzle ports 25 may be either tapered or straight. In the case of spray nozzle ports with straight threads a gasket may be provided between the outermost surface of the spray nozzle port and the respective spray nozzle to enhance the seal therebetween.

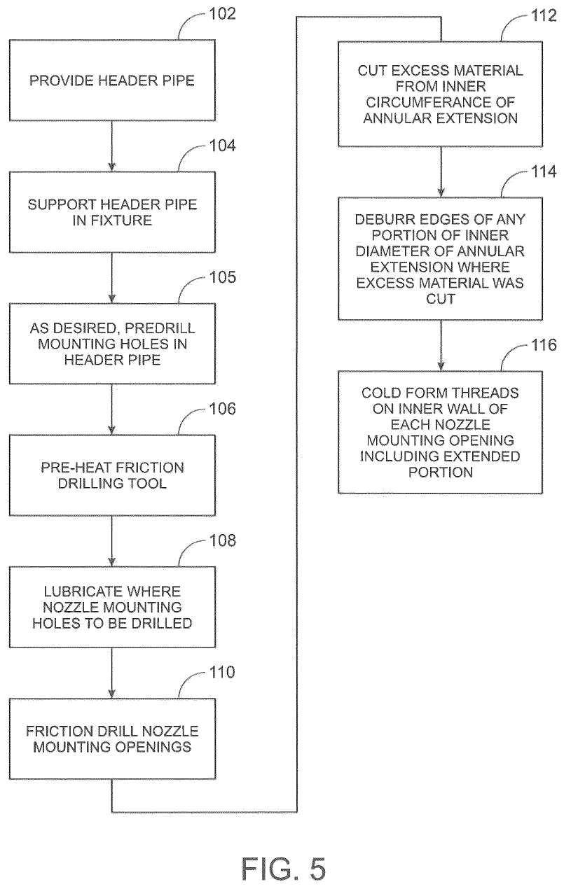

An exemplary process for manufacturing a spray header pipe 12 such as shown in FIGS. 2-4 is shown in the flow chart of FIG. 5. Advantageously, the process shown in FIG. 5 can be used to produce spray headers that are suitable for use in applications such as food service, chemical, pharmaceutical and paper plants requiring heightened performance, including superior leak resistance at elevated temperatures and pressures. As noted previously, one example of characteristics that can be achieved using a header pipe 12 made according to the process of FIG. 5 are outlined in ASME B31.3. While FIG. 5 illustrates the steps in a particular order, it should be understood that the steps could be performed in a different order than that shown.

Referring to FIG. 5, in a first step 102, a header pipe 12 such as described above is provided. The header pipe is supported in an appropriate fixture in step 104. The header pipe 12 may be cut to the desired length before or after it is placed in the fixture in step 104. Optionally, a friction drilling tool may be preheated in step 106. The preheating step 106 may be performed using a propane torch or other appropriate heat source. According to one embodiment, the flame of the torch is held on the tool for short period of time (e.g., approximately 30 seconds) while the friction drilling tool is rotating at a low RPM in order to provide an even heat. In other embodiments, preheating of the friction drill may not be performed.

In step 108, a friction-drilling lubricant may be applied at the locations where the friction drilled mounting openings 26 are to be drilled. Any suitable lubricant may be used. The nozzle mounting openings 26 are friction drilled in step 110. In this step 110, an appropriate friction drilling tool is fed into the external surface of the side wall 28 of the header pipe 12 to the appropriate depth at the desired locations for the spray nozzle ports 25. One example of a suitable friction drill is available from Flowdrill. The friction drill should be set to rotate at the appropriate spindle speed and the feed rate of the drill into the header pipe 12 should be set at the appropriate rate for the particular header being made. For example, the spindle speed and feed rate may depend on a variety of factors including the thickness of the header pipe and the diameter of the nozzle mounting opening 26 to be produced. For this step 110, the friction drilling tool may be supported in a CNC machine for radial movement relative to the fixtured header pipe in order to produce the friction drilled mounting openings 26 in the header pipe 12. Additionally, the friction drilling tool may be supported for axial movement relative to the header pipe 12 so that the friction drilling tool may be moved into the desired axial positions on the header pipe 12 for each of the spray nozzle ports 25. The lubricating step 108 may be performed sequentially before each mounting opening 26 is friction drilled in step 110. Alternatively, lubrication may be applied to all of the mounting opening locations before the friction drilling step 110 begins.

In some cases involving header pipes 12 having relatively closely spaced spray nozzle ports 25 arranged in an axial line, it may help with heat dissipation to not friction drill all of the mounting openings sequentially in step 110. For example, with a header pipe 12 having ten closely spaced spray nozzle ports 25, the mounting openings 26 may be friction drilled in a non-sequential order such as one, six, three, eight, five, ten, two, seven, four and then nine. This particular sequence is just one example and is not intended to be limiting. The non-sequential friction drilling of the mounting openings 26, as noted, helps with heat dissipation which can control deformation and lead to a more sound finished product.

Regardless of whether the mounting openings 26 are friction drilled non-sequentially, it may help with heat dissipation during the friction drilling step 110 to use a fixed dwell time between drilling individual mounting openings 26 to allow for heat dissipation in the header pipe 12 and the friction drilling tool.

With header pipe 12 having thicker side walls or sections with thicker side walls, it may be advantageous to predrill the header side wall 28 prior to the friction drilling process. In such cases, a non-friction drilling tool may be used to predrill the header side wall to a predetermined hole diameter that is less than the final size of the friction drilled opening. This optional predrilling step is referenced as step 105 in FIG. 5, although it may be performed in a different sequence that is illustrated in FIG. 5.

Once the mounting openings 26 are friction drilled, one or more clean-up steps are performed into order to remove excess material produced by the friction drilling. If not removed, this excess material could become dislodged during later usage of the header and lead to clogging of the spray nozzles attached to the header. In step 112 of the illustrated embodiment, for each spray nozzle port 25, excess material is cut from the inner circumferential wall of the annular extension 30 produced by the friction drilling process. In this step 112, a pointed cutting tool is interpolated around the inner circumferential wall of the annular extension 30 to remove the excess material. According to some embodiments, the removal of the excess material at the radially inner most end of the circumferential wall of each annular extension 30 can be important for ensuring that unwanted debris from the friction drilling process does not interfere with operation of the completed header.

In a further clean-up step 114, the inner circumferential wall of the annular extension 30 of each of the spray nozzle mounts 25 is deburred. More particularly, the edges of any portions of the inner circumferential wall of the annular extensions 30 from which excess material was cut in step 112 are deburred. The deburring step may be executed using a spring-loaded deburring tool.

After the annular extensions 30 of the spray nozzle ports 25 produced by the friction drill are cleaned-up, internal threads 32 may be provided in each of the spray nozzle mounts in step 116. According to one important aspect of the present disclosure, the internal threads 32 may be produced in step 116 by cold-forming. More specifically, a cold-form roll tap may be used to form the threads 32 in the inner circumferential wall of each spray nozzle port 25 including both the portion extending through the side wall 28 of the header pipe wall and the annular extension portion 30. A cold forming tap, which can also be referred to as a roll tap, creates threads by extruding the material in the friction drilled spray nozzle port 25 up into the thread form instead of removing material such as is done when cutting threads. This leads to a stronger thread that allows the spray header to be used in applications requiring enhanced leak resistance at elevated fluid temperatures and pressures. To facilitate tight and predictable gauging of the threaded mounting openings 26, specialized fixturing may be used to accurately and precisely hold the header pipe 12 during the threading forming step 116.

The following examples further illustrate the scope of the invention but should not be construed in any way as limiting the scope of the invention.

### Example 1

A pressure test was conducted at high temperature on a sample spray header pipe with friction drilled spray nozzle ports. This test demonstrated that the formed material of the friction drilled spray nozzle ports retained similar strength and ability to hold substantial pressure at high temperature as compared to room temperature.

The test was performed on the following samples:

TABLE 1

| Sample | Sample Description |
|---|---|
| 1 | 1 in pipe with nine ¼ inch NPT |
| | and eight ⅛ inch fittings |
| 2 | 1 in pipe with nine ¼ inch NPT |
| | and eight ⅛ inch fittings |
| 3 | 1 in pipe with nine ¼ inch NPT |
| | and eight ⅛ inch fittings |

The test was performed using a computer-controlled servo hydraulic pressure testing system at elevated temperature. The first test was performed with no turns of the fittings. The pipe was then pressurized until a visual leak was observed. The process was of rotating the fitting one turn and pressuring the pipe was repeated until either the threads failed due to torquing or tightening no longer resulted in higher pressure in subsequent iterations. The max pressure was recorded by a pressure transducer. The results were as follows:

TABLE 2

| Sample | No. of | Test | | |
|---|---|---|---|---|
| Number | Turns | Rate | Temp | Results |
| 1 | 0 | 40 psi/s | 149° C | Sample leaked from fittings |
| | | | | 9 to 17, max pressure |
| | | | | achieved 6720 psig. |
| 1 | 1 | 40 psi/s | 149° C | Sample leaked from fittings |
| | | | | 15 and 16, maximum pressure |
| | | | | achieved 8131 psig. |
| 1 | 2 | 40 psi/s | 149° C | Sample leaked from fittings |
| | | | | 15 and 17, max pressure |
| | | | | achieved 7929 psig. |
| 2 | 0 | 40 psi/s | 149° C | Sample leaked from fittings |
| | | | | 2, 4, 6 and 9 to 17, max |
| | | | | pressure achieved 7761 psig. |
| 2 | 1 | 40 psi/s | 149° C | Sample leaked from fittings |
| | | | | 10 to 17, max pressure |
| | | | | achieved 8241 psig. |
| 2 | 2 | 40 psi/s | 149° C | Sample leaked from fittings |
| | | | | 13 to 17, max pressure |
| | | | | achieved 8802 psig. |
| 2 | 3 | 40 psi/s | 149° C | Sample leaked from fitting |
| | | | | 15, max pressure achieved |
| | | | | 5845 psig. |
| 3 | 0 | 40 psi/s | 149° C | Sample leaked from fittings |
| | | | | 4, 5, 10 and 11, max pressure |
| | | | | achieved 7185 psig. |
| 3 | 1 | 40 psi/s | 149° C | Sample leaked from fittings |
| | | | | 9 and 10, max pressure |
| | | | | achieved 8487 psig. |
| 3 | 2 | 40 psi/s | 149° C | Sample leaked from fittings |
| | | | | 7 to 11 and 13 to 15, max |
| | | | | pressure achieved 6337 psig. |

### Example 2

A thread pull test was conducted at room temperature on a sample spray header pipe with friction drilled and threaded spray nozzle ports. This test demonstrated that the material and joint geometry of the spray nozzle ports retained the ability to hold substantial load after friction drilling and thread forming. The test also showed that the material of the spray nozzle ports retained its ductile nature.

The samples tested were ½ inch, schedule 40 SA312 TP316//L pipe with ⅛ inch NPT hole. The test results were as follows:

TABLE 3

| Specimen | Ultimate | Character of |
|---|---|---|
| No. | Applied Load (LBS) | Failure Location |
| 1 | 4044 | Ductile |
| 2 | 4924 | Ductile |
| 3 | 4576 | Ductile |

In another test, the samples tested were ¾ inch, schedule 40 SA312 TP316//L pipe with ⅛ inch NPT hole. The test results were as follows:

TABLE 4

| Specimen | Ultimate | Character of |
|---|---|---|
| No. | Applied Load (LBS) | Failure Location |
| 1 | 3499 | Ductile |
| 2 | 3236 | Ductile |
| 3 | 3999 | Ductile |

In another test, the samples tested were 1½ inch, schedule 40 SA312 TP316//L pipe with ⅛ inch NPT hole. The test results were as follows:

TABLE 5

| Specimen | Ultimate | Character of |
|---|---|---|
| No. | Applied Load (LBS) | Failure Location |
| 1 | 4613 | Ductile |
| 2 | 4467 | Ductile |
| 3 | 5006 | Ductile |

In another test, the samples tested were 1½ inch, schedule 40 SA312 TP316//L pipe with ¼ inch NPT hole. The test results were as follows:

TABLE 6

| Specimen | Ultimate | Character of |
|---|---|---|
| No. | Applied Load (LBS) | Failure Location |
| 1 | 7370 | Ductile |
| 2 | 6139 | Ductile |
| 3 | 7564 | Ductile |

### Example 3

A thread pull test similar to that described in Example 2 was conducted on a sample spray header pipe with a friction drilled and threaded spray nozzle port at −20° F. temperature. This test demonstrated that the material of the spray nozzle ports retained its ductile nature at low temperatures after friction drilling and thread forming.

The samples tested were ½ inch, schedule 40 pipe with ⅛ inch NPT. The results were as follows:

TABLE 7

| Specimen | Peak | Failure |
|---|---|---|
| No. | Load (LBS) | Mode |
| 1 | 5218 | Ductile |
| 2 | 5030 | Ductile |
| 3 | 5366 | Ductile |
| Average | 5205 | |
| Std. Dev. | 168 | |

The samples tested were 2 inch, schedule 40 pipe with ¼ inch NPT. The results were as follows:

TABLE 7

| Specimen | Peak | Failure |
|---|---|---|
| No. | Load (LBS) | Mode |
| 1 | 7019 | Ductile |
| 2 | 7456 | Ductile |
| 3 | 7083 | Ductile |
| Average | 7186 | |
| Std. Dev. | 236 | |

### Example 4

A macro examination was performed of a friction drilled spray nozzle port with formed threads. The spray nozzle mount was sliced transversely and longitudinally. This test demonstrated that the spray nozzle port was free of any impermissible material defects after the friction drilling and thread forming. The test were performed as follows:

TABLE 8

| Sample | | Type of | |
|---|---|---|---|
| No. | Size and Material | Sample | Results |
| 1 | ½ in sch 40 × 8 in SA312 | Transverse | Satisfactory |
| | TP316/L with 2 ⅛ inch NPT holes | | |
| 2 | ½ in sch 40 × 8 in SA312 | Longitudinal | Satisfactory |
| | TP316/L with 2 ⅛ inch NPT holes | | |
| 3 | 3/4 in sch 40 × 8 in SA312 | Transverse | Satisfactory |
| | TP316/L with 2 ⅛ inch NPT holes | | |
| 4 | 3/4 in sch 40 × 8 in SA312 | Longitudinal | Satisfactory |
| | TP316/L with 2 ⅛ inch NPT holes | | |
| 5 | 1-½ in sch 40 × 8 in SA312 | Transverse | Satisfactory |
| | TP316/L with 2 ⅛ inch NPT holes | | |
| 6 | 1-½ in sch 40 × 8 in SA312 | Longitudinal | Satisfactory |
| | TP316/L with 2 ⅛ inch NPT holes | | |
| 7 | 1-½ in sch 40 × 8 in SA312 | Transverse | Satisfactory |
| | TP316/L with 2 ¼ inch NPT holes | | |
| 8 | 1-½ in sch 40 × 8 in SA312 | Longitudinal | Satisfactory |
| | TP316/L with 2 ¼ inch NPT holes | | |

### Example 5

A microhardness test was performed on a sample spray header having a friction drilled spray nozzle port with formed threads. The spray nozzle port was sliced transversely and longitudinally. This test produced hardness information in various sections of the friction drilled spray nozzle mount with formed threads. The test results showed higher hardness values near the threads correlating to a higher material strength, and lower values further away from the threads.

The test included the following hardness results in HV0.5 at various locations on a ½ inch schedule 40×8 inch, SA312 TP316/L pipe with two ⅛ inch NPT holes:

TABLE 9

| | | | | | | | | | | | Key |
|---|---|---|---|---|---|---|---|---|---|---|---|
| Orientation | 1 | 2 | 3 | 4 | 5 | 6 | 7 | 8 | 9 | Avg | (C/NC/R) |
| Transverse | 285 | 300 | 289 | 232 | 233 | 236 | 188 | 215 | 195 | 241 | R |
| Longitudinal | 239 | 236 | 227 | 238 | 297 | 244 | 177 | 231 | 282 | 241 | R |

The test included the following hardness results in HV0.5 at various locations on a ¾ inch schedule 40×8 inch, SA312 TP316/L pipe with two ⅛ inch NPT holes:

TABLE 10

| | | | | | | | | | | | Key |
|---|---|---|---|---|---|---|---|---|---|---|---|
| Orientation | 1 | 2 | 3 | 4 | 5 | 6 | 7 | 8 | 9 | Avg | (C/NC/R) |
| Transverse | 260 | 244 | 225 | 236 | 228 | 214 | 173 | 171 | 185 | 215 | R |
| Longitudinal | 233 | 211 | 252 | 281 | 264 | 246 | 170 | 201 | 245 | 234 | R |

The test included the following hardness results in HV0.5 at various locations on a 1-½ inch schedule 40×8 inch, SA312 TP316/L pipe with two ⅛ inch NPT holes:

TABLE 11

| | | | | | | | | | | | Key |
|---|---|---|---|---|---|---|---|---|---|---|---|
| Orientation | 1 | 2 | 3 | 4 | 5 | 6 | 7 | 8 | 9 | Avg | (C/NC/R) |
| Transverse | 257 | 243 | 232 | 210 | 218 | 234 | 183 | 173 | 167 | 213 | R |
| Longitudinal | 251 | 254 | 272 | 263 | 206 | 208 | 163 | 159 | 208 | 224 | R |

The test included the following hardness results in HV0.5 at various locations on a 1-½ inch schedule 40×8 inch, SA312 TP3161/L pipe with two ¼ inch NPT holes:

TABLE 12

| | | | | | | | | | | | Key |
|---|---|---|---|---|---|---|---|---|---|---|---|
| Orientation | 1 | 2 | 3 | 4 | 5 | 6 | 7 | 8 | 9 | Avg | (C/NC/R) |
| Transverse | 244 | 228 | 268 | 246 | 262 | 270 | 212 | 192 | 184 | 234 | R |
| Longitudinal | 230 | 226 | 238 | 284 | 220 | 219 | 169 | 153 | 181 | 213 | R |

### Example 6

A microstructure examination was performed on a sample spray header having a friction drilled spray nozzle port with a formed thread. The spray nozzle port was sliced transversely and longitudinally. The test demonstrated no observable carbide precipitation in the material after it was friction drilled and formed. This indicates that the material retained its corrosion resistant properties without the need for subsequent annealing heat treatment.

TABLE 13

| Sample | | |
|---|---|---|
| No. | Description | Material |
| 1 | ½ in Sch 40 × 8 in with ⅛ inch | SA312 TP316/L |
| | NPT hole - Transverse | |
| 2 | ½ in Sch 40 × 8 in with ⅛ inch | SA312 TP316/L |
| | NPT hole - Longitudinal | |
| 3 | ¾ in Sch 40 × 8 in with ⅛ inch | SA312 TP316/L |
| | NPT hole - Transverse | |
| 4 | ¾ in Sch 40 × 8 in with ⅛ inch | SA312 TP316/L |
| | NPT hole - Longitudinal | |
| 5 | 1-½ in Sch 40 × 8 in with ⅛ inch | SA312 TP316/L |
| | NPT hole - Transverse | |
| 6 | 1-½ in Sch 40 × 8 in with ⅛ inch | SA312 TP316/L |
| | NPT hole - Longitudinal | |
| 7 | 1-½ in Sch 40 × 8 in with ¾ inch | SA312 TP316/L |
| | NPT hole - Transverse | |
| 8 | 1-½ in Sch 40 × 8 in with ¼ inch | SA312 TP316/L |
| | NPT hole - Longitudinal | |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A spray header assembly for discharging a fluid onto a spray target, the spray header assembly comprising:
a spray header pipe with an elongated tubular side wall with a hollow interior that defines an internal fluid passageway, the header pipe being made of a material;
the spray header pipe including a plurality of spray nozzle ports, each spray nozzle port including a respective mounting opening that extends through the side wall of the spray header pipe and communicates with the internal fluid passageway;
each spray nozzle port including a respective annular extension that extends radially inwardly from an inner surface of the side wall into the internal fluid passageway such that each mounting opening extends from an external surface of the side wall through the side wall and through the annular extension to reach the internal fluid passageway, each mounting opening including the corresponding annular extension being internally threaded;
wherein each annular extension extends seamlessly from the header pipe and is formed unitarily from the material of the header pipe; and
a respective spray nozzle secured in each mounting opening.

2. The spray header assembly of claim 1, wherein each mounting opening is friction-drilled.

3. The spray header assembly of claim 1, wherein the internal threads of each mounting opening are cold-formed.

4. The spray header assembly of claim 1, wherein an upstream end of the header pipe is configured for connection to a pressurized liquid supply.

5. The spray header assembly of claim 1, wherein the header pipe has a diameter of 0.5 inches to 2 inches.

6. The spray header assembly of claim 1, wherein the side wall of the header pipe has a thickness of schedule 10 to schedule 40.

7. The spray header assembly of claim 1, wherein the header pipe is made of stainless steel.

8. A method of making a spray header, the method comprising the steps of:
supporting a header pipe in a fixture;
friction drilling a plurality of mounting openings in an external surface of the header pipe by feeding a friction drilling tool into a side wall of the header pipe, each friction drilled mounting opening being at a desired location of a spray nozzle port, the friction drilling forming an annular extension at each mounting opening that extends seamlessly and radially inwardly from an inner wall of the header pipe with each annular extension being formed unitarily with the header pipe;
removing excess material from an internal circumferential wall of each mounting opening including in the respective annular extension; and
cold forming internal threads in the internal circumferential wall of each of the mounting openings including in the respective annular extension.

9. The method of claim 8, further including the step of pre-drilling holes at the desired locations of the spray nozzle ports to a depth less than a full wall thickness of the side wall using a non-friction drilling tool.

10. The method of claim 8, further including the step of applying a friction-drilling lubricant at the desired locations of the spray nozzle ports prior to the friction drilling step.

11. The method of claim 8, wherein the mounting openings are friction drilled in a non-sequential manner.

12. The method of claim 8, wherein a fixed dwell time is provided between friction drilling of the individual mounting openings.

13. The method of claim 8, wherein the removing excess material step is performed by interpolating a cutting tool around the internal circumferential wall of the corresponding mounting opening.

14. The method of claim 8, further including the step of deburring the internal circumferential wall of the corresponding mounting opening after the removing excess material step.

15. The method of claim 8, wherein the cold forming of the internal threads is performed using a cold-form roll tap that extrudes a material of internal circumferential wall of the corresponding to form the threads.

16. A spray header assembly for discharging a fluid onto a spray target, the spray header comprising:
a spray header pipe with an elongated tubular side wall with a hollow interior that defines an internal fluid passageway, the header pipe being made of a material;
the spray header pipe including a plurality of spray nozzle ports, each spray nozzle port including a respective mounting opening that extends through the side wall of the spray header pipe and communicates with the internal fluid passageway;
each spray nozzle port including a respective annular extension that extends radially inwardly from an inner surface of the side wall into the internal fluid passageway such that each mounting opening extends from an external surface of the side wall through the side wall and through the annular extension to reach the internal fluid passageway, each mounting opening including the corresponding annular extension being internally threaded;
wherein each annular extension extends seamlessly from the header pipe and is formed unitarily from the material of the header pipe.

17. The spray header of claim 16, wherein each mounting opening is friction-drilled.

18. The spray header of claim 16, wherein the internal threads of each mounting opening are cold-formed.

19. The spray header of claim 16, wherein the header pipe has a diameter of 0.5 inches to 2 inches.

20. The spray header of claim 16, wherein the side wall of the header pipe has a thickness of schedule 10 to schedule 40.
